(19) United States
(12) Patent Application Publication
(10) Pub. No.: US 2015/0171927 A1
(43) Pub. Date: Jun. 18, 2015

(54) ELECTRONIC DEVICE, CONTAINER, MANUFACTURING METHOD OF CONTAINER AND MOUNTING FIXTURE FOR CONTAINER

(71) Applicant: NIKON CORPORATION, Tokyo (JP)

(72) Inventors: Sho Somiya, Yokohama (JP); Kenjiro Iohara, Kamakura (JP); Hiromi Kuwata, Chiba (JP); Noriaki Mochimizo, Kawasaki (JP); Shutaro Teramoto, Tokyo (JP); Masakazu Sekiguchi, Kawasaki (JP)

(73) Assignee: NIKON CORPORATION, Tokyo (JP)

(21) Appl. No.: 14/407,791

(22) PCT Filed: Nov. 12, 2012
(86) PCT No.: PCT/JP2012/079232

§ 371 Date: Dec. 12, 2014

(30) Foreign Application Priority Data
Jun. 15, 2012 (JP) 2012-135901
Jun. 15, 2012 (JP) 2012-135902

(51) Int. Cl. H04B 5/00; H04B 13/00

(52) U.S. Cl. CPC H04B 5/0031; H04B 13/005

(57) ABSTRACT

An electronic device includes: a communication unit (21, 22, 31, 31) that performs a near field communication or an intra-body communication with a container-side communication unit (11, 12) that is provided on a container (50B) that is capable of housing substance or a cover that covers at least a part of the container; and an input unit (28, 43) that inputs information relating to the substance in the container via the container-side communication unit and the communication unit.

### TECHNICAL FIELD

The present invention relates to an electronic device, a container, a manufacturing method of container and a mounting fixture for container.

### BACKGROUND ART

Conventionally, there are various suggestions for preventing a heat stroke. For example, Patent Document 1 or the like suggests a device that has a wristwatch having a biometric sensor or a hygrograph sensor and measures thermal index of a user.

### PRIOR ART DOCUMENTS

### Patent Documents

Patent Document 1: Japanese Patent Application Publication No. 2009-34223

### SUMMARY OF THE INVENTION

### Problems to be Solved by the Invention

However, in a conventional guidance system, an actual liquid intake condition of a user is not considered.

The present invention has been made in view of the above problem, and has an object to provide an electronic device that is capable of storing a substance intake of a user. And, the present invention has an object to provide a container that is capable of providing information of a container main body to another device, a manufacturing method of the container, and a mounting fixture for container that is capable of providing information of a container to another device.

### Means for Solving the Problems

An electronic device according to the present invention includes: a communication unit that performs a near field communication or an intra-body communication with a container-side communication unit that is provided on a container that is capable of housing substance or a cover that covers at least a part of the container; and an input unit that inputs information relating to the substance in the container via the container-side communication unit and the communication unit.

In this case, a storage unit may be provided that stores an intake amount of the substance by a user based on the information that is input by the input unit. In this case, the storage unit may store a total intake amount of the user for a predetermined period. And, a first report unit may be provided that reports at least one of an amount or a time of which the user should take the substance next, based on the information input by the input unit. And, a second report unit may be provided that reports when the communication unit does not perform the communication for a predetermined period. In this case, the second report unit may report to a person that is different from the user. And, a setting unit that sets the predetermined period may be provided in accordance with an environment of the user.

In the electronic device of the present invention, a detection unit that detects a datum relating to a body sensory of the user may be provided. In this case, the detection unit may have a biometric sensor that detects biometric information of the user. And, the detection unit may have an environment sensor that detects information relating to an environment where the user is positioned. And, the detection unit may have an imaging unit that takes an image of the user.

In the electronic device of the present invention, the container-side communication unit may be provided on the container; and the input unit may input a component of the substance. In this case, a calculation unit may be provided that calculates an intake amount of the component based on the information relating to the amount of the substance that is input by the input unit and the information of the component of the substance. And, the substance may be liquid.

A container of the present invention includes: a container main body that houses substance; and a communication unit that is provided on the container main body and is capable of communicating with another device with use of a communication via a human body or a near field communication.

In this case, the communication unit may have an electrode unit that is used for the communication via the human body; and the electrode unit may be located on a position of the container main body that is held by the user. And, the communication unit may have an electrode unit that is used for the communication via a human body; and the electrode unit may be provided near an opening of the container main body through which the user takes the substance. And, the electrode unit may have a sheet-shaped electrode.

A detection unit that detects the information relating to the amount of the substance may be provided. And, the detection unit may detect a changing of the amount of the substance. And, the detection unit may be a load sensor that is provided on a bottom of the container main body. And, a first storage unit that stores a detection result of the detection unit may be provided, and the communication unit may transmit information stored in the first storage unit to the another device.

In the container of the present invention, a second storage unit that stores information relating to the substance may be provided, and the communication unit may transmit information stored in the second storage unit to the another device. And, the communication may be detachable. And, the substance may be liquid.

A manufacturing method of container of the present invention includes: housing substance in a container main body; and attaching a communication unit to the container, the communication unit being capable of communicating with another device with use of a communication via a human body or a near field communication.

In this case, providing a load sensor on a bottom of the container main body may be included. And, providing a storage unit storing information relating to the substance on the container main body may be included.

A manufacturing method of container of the present invention includes: detaching a communication unit from a first container, the communication unit being capable of communicating with another device with use of a communication via a human body or a near field communication; and attaching the detached communication unit to a second container that is different from the first container.

In this case, detaching a load sensor from the first container may be included, and attaching the detached load sensor to the second container or a third container that is different from the second container may be included.

A mounting fixture for container of the present invention includes: a mounting fixture portion that can be fixed to a container where substance is housed; and a communication unit that is provided on the mounting fixture portion and is capable of communicating with another device with use of a communication via a human body or a near field communication.

### Effects of the Invention

An electronic device of the present invention is capable of storing a substance intake of a user. A container of the present invention is capable of providing information of a container main body to another device. And a manufacturing method of the container of the present invention is capable of manufacturing a container that is capable of providing information of a container main body to another device. A mounting fixture for container of the present invention is capable of providing information of a container to another device.

### BRIEF DESCRIPTION OF DRAWINGS

FIG. 1 illustrates a block diagram of an information processing system in accordance with an embodiment;

FIG. 2 illustrates a usage example of an information processing system in accordance with an embodiment;

FIG. 3 illustrates an example of a weight table stored in a memory of a device for container;

FIG. 4A illustrates an example of a user information table stored in a flash memory of a wristwatch;

FIG. 4B illustrates an example of a liquid intake table;

FIG. 5A illustrates an example of a user information table stored in a flash memory of a mobile device;

FIG. 5B illustrates an example of a liquid intake table;

FIG. 6 illustrates a process performed by a sweat estimation unit;

FIG. 7 illustrates a flowchart of a process (during liquid intake) performed by a control unit of a wristwatch;

FIG. 8 illustrates a flowchart of a process (normal) performed by a control unit of a wristwatch;

FIG. 9 illustrates a flowchart of a process performed by a control unit of a mobile device;

FIG. 10 illustrates a PET bottle of a modified embodiment;

FIG. 11 illustrates an example of a datum stored in a memory of FIG. 10;

FIG. 12A illustrates a flowchart of a manufacturing method of a PET bottle drink;

FIG. 12B illustrates a recycle process of a PET bottle;

FIG. 13A and FIG. 13B illustrate an example of a cover for a PET bottle of a modified embodiment; and

FIG. 14 illustrates an example of a container having an inner bottom of a modified embodiment.

### MODES FOR CARRYING OUT THE INVENTION

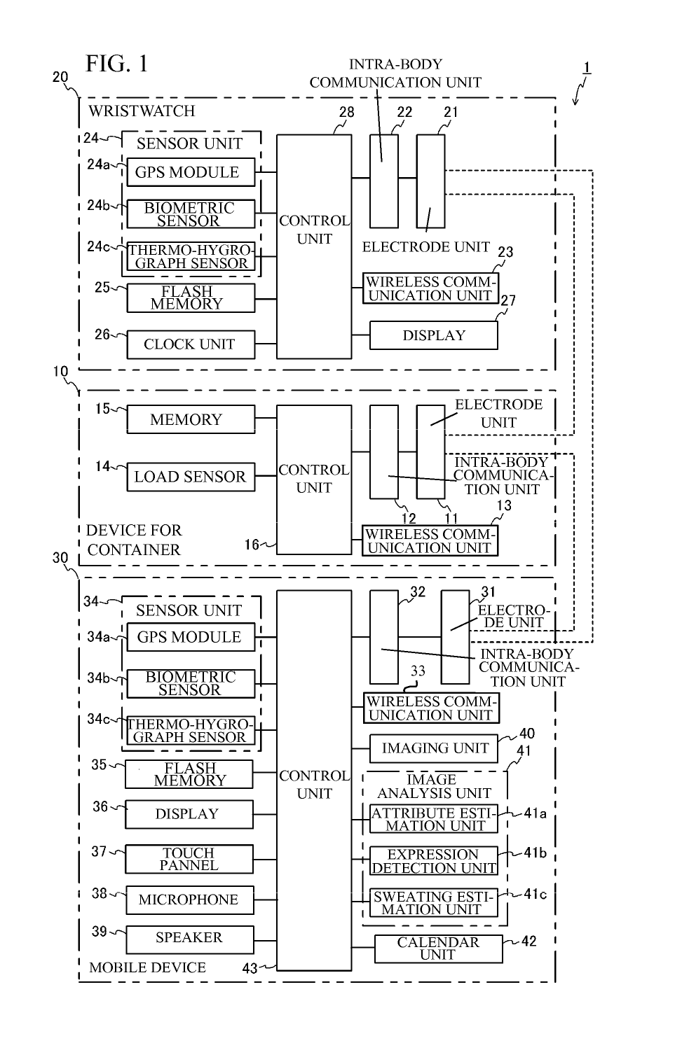

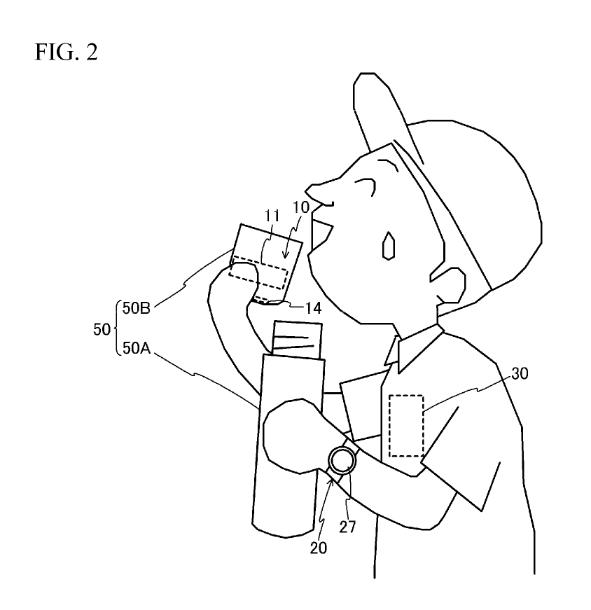

Hereinafter, a description will be given of details of an information processing system 1 in accordance with an embodiment with reference to FIG. 1 to FIG. 9. FIG. 1 illustrates a block diagram of the information processing system 1. FIG. 2 illustrates a usage example of the information processing system 1.

The information processing system 1 is a system that records a user's taking of liquid (water, tea, juice or the like) that is fluid in a container with use of an intra-body communication and promotes the user's taking of liquid when the user lacks of an intake amount.

In the embodiment, the information processing system 1 has a device 10 for a container that is provided on a container (water bottle in the embodiment) such as a PET bottle, a water bottle, a cup, a mug cup or a can, a wristwatch 20 that is fixed to a user, and a mobile device 30 that a user holds.

(The device 10 for container) As illustrated in FIG. 2, the device 10 for container is provided on a second portion 50B (a portion acting as a lid or a cup hereinafter referred to as a cup portion) that is one of a first portion 50A (a portion housing liquid) and the second portion 50B (cup portion). As illustrated in FIG. 1, the device 10 for container has an electrode unit 11, an intra-body communication unit 12, a wireless communication unit 13, a load sensor 14, a memory 15 and a control unit 16.

The electrode unit 11 has a signal electrode and a ground electrode and is an electrode for communication with the wristwatch 20 or the mobile device 30 via a user. As illustrated in FIG. 2, the electrode unit 11 is provided at a position that is easy to reach by a hand of a user. A sheet-shaped electrode can be used as the electrode unit 11. When the sheet-shaped electrode is used as the electrode unit 11 in this manner, it is possible to distinguish a user based on a contact area between the sheet-shaped electrode and a hand (finger). An intra-body communication with use of the electrode unit 11 can be achieved not only when hands of the user are bare but also when the user wears gloves (the hands and the electrode face with each other).

The intra-body communication unit 12 has a transmission unit that has an electrical circuit having a band pass filter, modulates a transmit data and generates a transmit signal. The intra-body communication unit 12 may have a receiving function. In the embodiment, information relating to taking of liquid with use of the cup portion 50B of a container 50 by a user is transmitted to the wristwatch 20 or the mobile device 30.

The wireless communication unit 13 performs a communication for a buffer when an intra-body communication between the device 10 for container and an outer device (the wristwatch 20 or the mobile device 30) is not achieved, and can use various wireless methods.

The load sensor 14 is, for example, a load cell that is provided on a bottom portion of the cup portion 50B of the container 50, and measures weight of the liquid housed in the cup portion 50B. In the embodiment, it is possible to estimate an amount of the liquid taken by a user, based on a changing of the load detected by the load sensor 14.

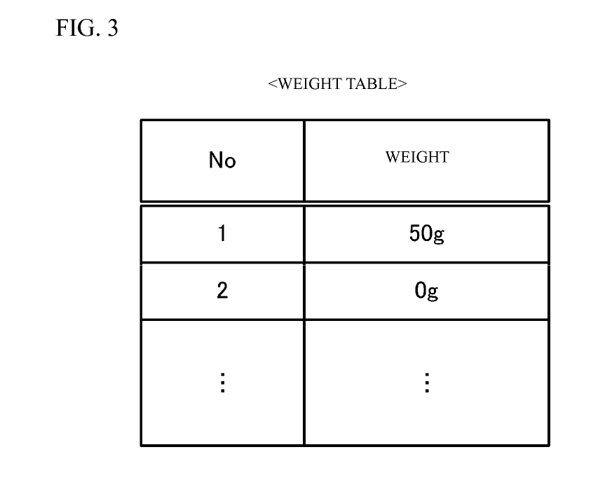

The memory 15 is anyone of a non-volatile memory or a volatile memory, and stores the weight of the liquid detected by the load sensor 14. FIG. 3 illustrates an example of a weight table stored in the memory 15. As illustrated in FIG. 3, weights of the liquid are sequentially stored in the weight table. In FIG. 3, values obtained by subtracting a weight of the cup portion 50B itself of the container 50 from the values measured by the load sensor 14 are stored.

The control unit 16 controls communications of the intra-body communication unit 12 or the wireless communication unit 13, and performs storing data in the memory 15.

(The wristwatch 20) The wristwatch 20 has an electrode unit 21, an intra-body communication unit 22, a wireless communication unit 23, a sensor unit 24, a flash memory 25, a clock unit 26, a display 27 and a control unit 28.

The electrode unit 21 has a signal electrode and a ground electrode and is an electrode for communicating with the device 10 for container or the mobile device 30 via a user. The electrode unit 21 is provided on an opposite side of the display 27 so that the electrode unit 21 tends to contact a wrist of a user.

The intra-body communication unit 22 has a transmit-receive unit that has an electrical circuit having a band pass filter, demodulates an input (received) receive signal and generates a receive data. On the other hand, the intra-body communication unit 22 modulates a transmit data and generates a transmit signal.

The wireless communication unit 23 performs a communication for a buffer when an intra-body communication with the device 10 for container or the mobile device 30 is not achieved, and can use various wireless methods.

The sensor unit 24 has a GPS module 24a, a biometric sensor 24b and a thermo-hygrograph sensor 24c.

The GPS (Global Positioning System) module 24a is a sensor to detect a position (for example, degrees of latitude and longitude) of the wristwatch 20 and can detect a position of the container 50 indirectly.

The biometric sensor 24b is a sensor to obtain biometric information of a user using the wristwatch 20, and is provided on the same face as the electrode unit 21 so as to contact a wrist of the user. For example, the biometric sensor 24b obtains a body temperature, a blood pressure, a pulse, a sweat amount or the like of a user.

The biometric sensor 24b radiates a light toward a user with use of a light-emitting diode, receives a reflected light from the user in accordance with the light, and detects the pulse, as disclosed in Japanese Patent Application Publication No. 2001-276012 (U.S. Pat. No. 6,526,315). For example, the biometric sensor 24b of a wristwatch type is disclosed in Japanese Patent Application Publication No. 2007-215749 (US Patent Publication No. 2007-019718).

The thermo-hygrograph sensor 24c is a sensor to measure a thermo-hygrograph of an environment where a user exits, and is provided on a face that is different from a face on which the electrode unit 21 or the biometric sensor 24b is provided, so that the thermo-hygrograph sensor 24c does not contact human body of the user. In the embodiment, a temperature sensor and a humidity sensor are integrated into a single chip. However, they may be provided individually. A detection method of the thermo-hygrograph sensor 24c can be selected arbitrarily.

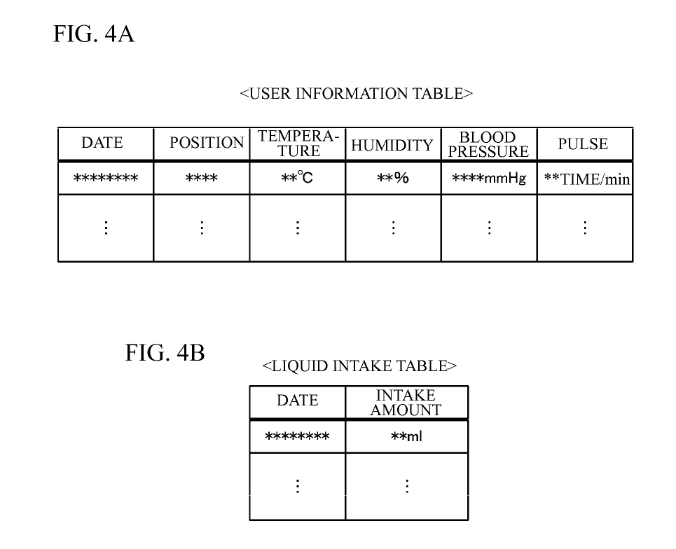

The flash memory 25 is a non-volatile semiconductor memory, and stores a program for controlling the wristwatch 20 executed by the control unit 28, each parameter for controlling the wristwatch 20, each data detected by the sensor unit 24, a datum relating to a liquid intake amount of a user received by the device 10 for container. For example, the flash memory 25 stores a user information table illustrated in FIG. 4A and a liquid intake table illustrated in FIG. 4B. The user information table of FIG. 4A stores a date, a position, a temperature, a humidity, a body temperature, a blood pressure and a pulse. The liquid intake table of FIG. 4B stores a date of intake and an intake amount. A liquid intake amount of a user per day may be stored in the liquid intake table of FIG. 4B.

The clock unit 26 has a normal clock function, generates date information, inputs time information transmitted by an originating station with use of a radio receiving circuit, corrects the date information, and so on.

For example, the display 27 is a display using a liquid crystal display element, is provided on a main face of the wristwatch 20 (a face having a dial plate of a normal clock), that is, a face that is different from a face where the electrode unit 21 or the biometric sensor 24b is provided and shows date information or various information. In the embodiment, the display 27 is used for promoting a user's liquid intake or reporting lack of intake liquid.

The control unit 28 has a CPU and controls a whole of the wristwatch 20. In the embodiment, the control unit 28 recognizes a liquid intake condition of a user by the communication with the device 10 for container, promotes the liquid intake of the user based on the environment around the user and the condition of the user, and performs a control for reporting the lack of liquid intake.

(The mobile device 30) The mobile device 30 is an information device used under a condition that a user carries the mobile device 30. A mobile phone, a smart phone, a PHS (Personal Handy-phone System), a PDA (Personal Digital Assistant) or the like can be used as the mobile device 30. In the embodiment, the mobile device 30 is a smart phone. The mobile device 30 has a phone function, a communication function for accessing internet or the like, a data processing function for executing a program and so on.

The mobile device 30 has an electrode unit 31, an intra-body communication unit 32, a wireless communication unit 33, a sensor unit 34, a flash memory 35, a display 36, a touch panel 37, a microphone 38, a speaker 39, an imaging unit 40, an image analysis unit 41, a calendar unit 42, and a control unit 43, as illustrated in FIG. 1.

The mobile device 30 stores a liquid intake amount of a user by an intra-body communication or a wireless communication with the device 10 for container, as well as the wristwatch 20. Therefore, one of the wristwatch 20 and the mobile device 30 can be omitted. A common function between the wristwatch 20 and the mobile device 30 can be omitted. In the embodiment, a description will be given of a case in which the wristwatch 20 and the mobile device 30 complement each other's function.

The electrode unit 31 has a signal electrode and a ground electrode, and communicates with the device 10 for container or the wristwatch 20 via a user. The intra-body communication unit 32 has a transmit-receive unit that has an electrical circuit having a band pass filter, modulates an input (received) receive signal, generates a receive data, modulates a datum to be transmitted and generates a transmit signal. There are a current system in which a weak current is flown into a human body, the current is modulated, and information is conducted, and an electrical field system in which an electrical field induced on a surface of a human body is modulated and information is conducted, in the intra-body communication. In the case of the electrical field system, the intra-body communication can be achieved even if a user does not contact the electrode unit 31 directly. Therefore, in the embodiment, the electrical field system is used so that the intra-body communication is achieved even if a user puts the mobile device 30 in a pocket (for example, a breast pocket).

When a user puts on one of the wristwatch 20 and the mobile device 30 and the intra-body communication is achieved between the put device and the device 10 for container, at least the liquid intake of a user has to be recorded.

On the other hand, when a user puts on both the wristwatch 20 and the mobile device 30, one of the devices acts as a master and the other acts as a slave. The device acting as a slave preferentially performs an intra-body communication with the device 10 for container. In the embodiment, when a user puts on both the wristwatch 20 and the mobile device 30, the wristwatch 20 acts as a slave. And, the intra-body communication between the device 10 for container and the wristwatch 20 or a communication (receiving and transmitting of a datum) by the wireless communication units 13 and 23 for a buffer is performed.

The wireless communication unit 33 and the sensor unit 34 substantially have the same structure as the wireless communication unit 23 and the sensor unit 24 of the wristwatch 20 mentioned above. The thermo-hygrograph sensor 24c of the wristwatch 20 measures a temperature and a humidity of an environment around a user. Therefore, a thermo-hygrograph sensor 34c of the mobile device 30 has only to be provided on a surface of the mobile device 30 so as to measure the temperature and the humidity of a user. That is, the thermo-hygrograph sensor 34c detects the temperature and the humidity under a condition that a user carries the mobile device 30 or the temperature and the humidity under a condition that the user puts the mobile device 30 in a breast pocket.

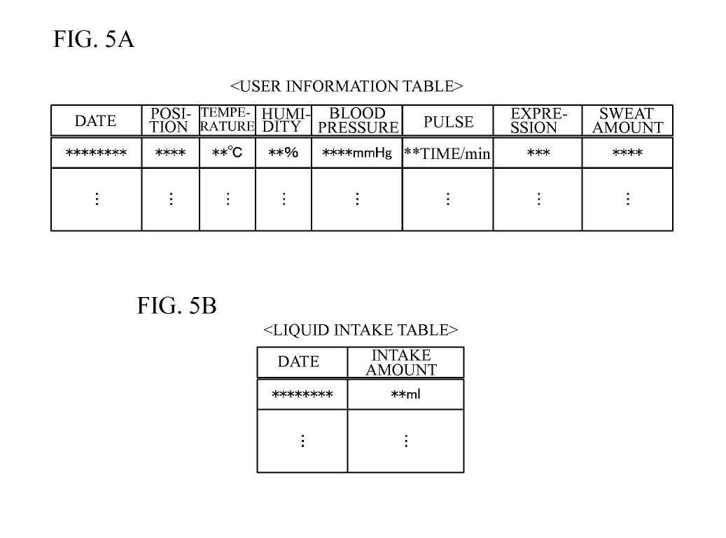

The flash memory 35 is a non-volatile semiconductor memory and stores a program for controlling the mobile device 30 executed by the control unit 43, each parameter for controlling the mobile device 30, each data detected by the sensor unit 34, a datum based on an image taken by the imaging unit 40, and a datum relating to a liquid intake of a user. The flash memory 35 stores the user information table illustrated in FIG. 5A and the liquid intake table illustrated in FIG. 5B. The user information table of FIG. 5A stores a date, a position, a temperature, a humidity, a body temperature, a blood pressure, a pulse, an expression of a face, and sweat amount. The liquid intake table of FIG. 5B stores an intake date and an intake amount. The liquid intake table of FIG. 5B may record a liquid intake amount of a user per day.

The display 36 is provided in the mobile device 30 and shows an image, various information, and a manipulated input image such as buttons. For example, the display 36 is a device using a liquid crystal display element.

The touch panel 37 inputs information in accordance with a contacting of a user. The touch panel 37 is provided on the display 36 or is built in the display 36. Therefore, the touch panel 37 inputs various information when a user touches the surface of the display 36. For example, a user may input liquid intake amount per day in advance. However, the control unit 43 may automatically set the liquid intake amount of a user in accordance with an output of the sensor unit 34, an analysis result of an image analysis unit 41 described later and an output (season or the like) of the calendar unit 42 instead of inputting a liquid intake amount of a user.

The microphone 38 is provided near the display 36 of the mobile device 30 and is positioned near a mouth when a user uses a phone function. The speaker 39 is provided near the display 36 of the mobile device 30 and is positioned near an ear when a user uses the phone function.

The imaging unit 40 is provided on a same face where the display 36 and the touch panel 37 are provided around the speaker 39. The imaging unit 40 takes an image of a condition of a user when the user carries (uses) the mobile device 30. The imaging unit 40 has an imaging lens, an imaging element (CCD and CMOS device) arrayed along a RGB Bayer and so on. Another imaging unit that is different from the imaging unit 40 may be provided on a face (for example, a reverse face) that is different from the face where the display 36 and the touch panel 37 are provided.

An infrared light camera may be used instead of the imaging unit 40 or together with the imaging unit 40. An infrared light camera of a passive type sensing an infrared light radiated from a human may be used as the infrared camera. In this case, when a log of heat amount radiated from a user operating the mobile device 30 is obtained by the infrared light camera, it is possible to know a discharge amount of an infrared light of a user at a normal time.

The image analysis unit 41 analyzes an image taken by the imaging unit 40 (an infrared camera may be included). In the embodiment, the image analysis unit 41 has an attribute estimation unit 41a, an expression detection unit 41b, and a sweating estimation unit 41c.

When an image taken by the imaging unit 40 includes a face image, the attribute estimation unit 41a estimates a sex and an age group of the face image. In the embodiment, when an attribute of a user is detected from the face image of the user, inputting of an attribute by a user may be omitted. Japanese Patent No. 4273359 (Japanese Patent Application Publication No. 2009-86901 and US Patent Publication No. 2010-0217743) discloses a determination of a sex or a determination of an age group from an image.

The expression detection unit 41b compares a face image data taken by the imaging unit 40 with a face expression data stored in the flash memory 35 and detects the expression of a user. An expression detection unit 53 detects an expression such as a smiley face, a crying face, an anger face, a surprising face, a face with a frown, a tensed face or a relaxing face. The flash memory 35 stores a plurality of expression data. US Patent Publication No. 2008-037841 discloses an example of detection of a smiley face. US Patent Publication No. 2008-292148 discloses an example of detection of a face with frown.

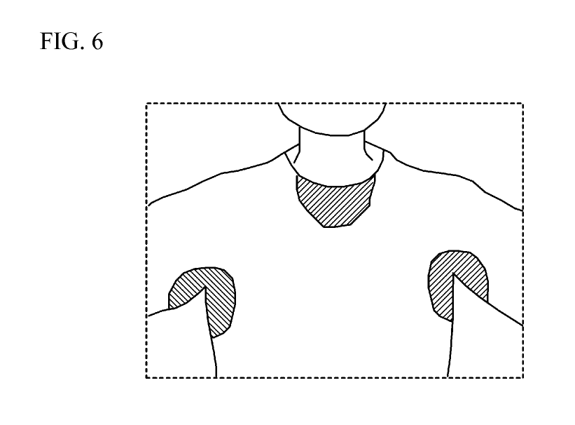

The sweating estimation unit 41c estimates a sweating condition of a user based on a RGB output of an imaging element of a specific portion such as a neck or a side. FIG. 6 illustrates an example of an image taken by the imaging unit 40. As illustrated in FIG. 6, when a user sweats, a color of portions of a cloth of the user such as a neck and a side changes because of sweating. Therefore, the sweating estimation unit 41c estimates a sweating condition of a user from the changing of the color. The sweating estimation unit 41c may estimate a sweating amount of a user from an output of an infrared camera.

The calendar unit 42 obtains time information such as a year, a month, a day or a time, and outputs the time information to the control unit 43.

The control unit 43 has a CPU and controls a whole of the mobile device 30. In the embodiment, the control unit 43 controls a log collection relating to liquid intake by a user.

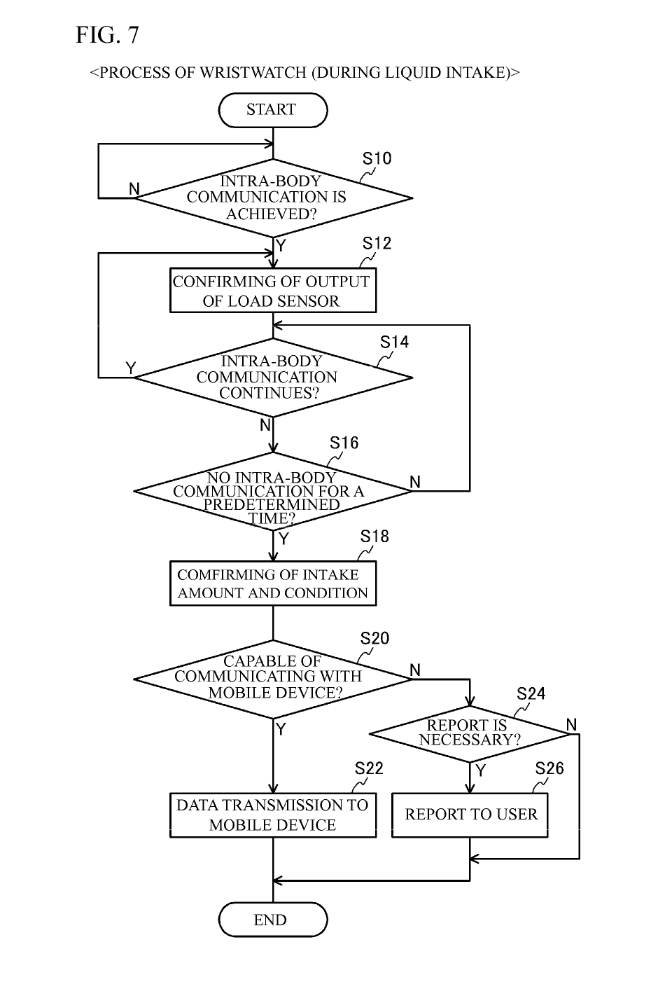

(Process of the information processing system 1) Next, a description will be given of processes of the information processing system 1 of the embodiment, with reference to flowcharts of FIG. 7 to FIG. 9.

(Process during liquid intake by the wristwatch 20 (the control unit 28)) FIG. 7 illustrates a flowchart relating to recording of liquid intake of a user by the control unit 28 of the wristwatch 20. The user puts the wristwatch on his wrist and puts the mobile device 30 in his breast pocket.

In the process of FIG. 7, in the step S10, the control unit 28 waits until the intra-body communication is achieved. In this case, the intra-body communication is achieved when the user holds the container 50 (the cup portion 50B) with his hand. At the timing, the control unit 28 executes Step S12.

In the Step S12, the control unit 28 obtains a weight of the cup portion 50B before liquid intake of the user from the load sensor 14 by the communication with the device 10 for container. When the user takes the liquid in the cup portion 50B in two or more stages, the control unit 16 stores a changing of the weight of the cup portion 50B including the liquid in the memory 15 (the weight table of FIG. 3).

Next, in the step S14, the control unit 28 determines whether the intra-body communication with the device 10 for container continues. The Step S14 is a process for confirming whether the liquid intake of the user continues. While the intra-body communication is achieved, the Step S12 and the Step S14 are repeated. At a time when the intra-body communication is not achieved, Step S16 is executed.

When the Step S16 is executed, the control unit 28 determine whether a predetermined time passes from a time when the intra-body communication is off. The Step S16 is executed for estimating termination of the liquid intake surely by waiting for a passage of a predetermined time, because the cup portion 50B is not always held continuously and the liquid may be taken in stages when a user takes the liquid.

For example, the predetermined time may be changed according to the capacity of the cup portion 50B. For example, the control unit 28 extends the predetermined time when the capacity of the cup portion 50B is 250 ml, compared to when the capacity of the cup portion 50B is 100 ml. The control unit 28 may determine the predetermined time in accordance with the output of the load sensor 14 (a remaining amount of the liquid). For example, the control unit 28 may reduce the predetermined time as the remaining amount gets smaller.

The control unit 28 returns to the Step S14 within a predetermined time (for example, a few tens of seconds) from a time when the intra-body communication is off, and executes Step S18 when the predetermined time passes from the time when the intra-body communication is off. When the Step S14 is executed again and it is determined as “Yes” in the Step S14 (the intra-body communication is achieved again), the control unit 28 confirms the output of the load sensor 14 at the time (just before the intra-body communication is achieved) (S12). The control unit 28 may execute the Step S18 when it is determined that the cup portion 50B is empty based on the output of the load sensor 14.

When the Step S18 is executed, the control unit 28 confirms the liquid intake amount of the user and the condition of the user (an output of the biometric sensor 24b or a thermo-hygrograph sensor, a current position of the user detected by the GPS module 24a, a current date detected by the clock unit 26), and updates the user information table of FIG. 4A and the liquid intake table of FIG. 4B stored in the flash memory 25. The liquid intake amount of the user is a liquid amount that is obtained by subtracting the weight of a content of the cup portion 50B at the time when the Step S18 is executed from the weight of a maximum content of the cup portion 50B after the intra-body communication is achieved for the first time.

While the user takes the liquid, there may be cases where the output of the load sensor 14 is not stable or cannot be measured because the cup portion 50B is inclined. In these cases, the control unit 28 may obtain the output of the load sensor 14 via the wireless communication units 13 and 23 and may confirm the remaining amount of the liquid in the cup portion 50B when it is determined as “Yes” in the Step S16.

In the Step S18, the control unit 28 confirms the sweating condition of the user or whether the environment causes a heat stroke, based on a current data of the user information table of FIG. 4A (the output of the biometric sensor 24b or the output of the thermo-hygrograph sensor 24c).

Next, in Step S20, the control unit 28 determines whether a communication can be achieved with the mobile device 30. When it is determined as “Yes” in the Step S20, that is, when the communication with the mobile device 30 can be achieved, the control unit 28 transmits each data stored in the flash memory 25 in the Step S18 to the mobile device 30 via the wireless communication units 23 and 33, in Step S22. After the Step S22, all processes of FIG. 7 are terminated.

On the other hand, when it is determined as “No” in the Step S20, that is, when the communication with the mobile device 30 cannot be achieved, the control unit 28 determines whether a report to the user is necessary in Step S24. When it is determined as “No” in the Step S24, all processes of FIG. 7 are terminated. When it is determined as “Yes” in the Step S24, Step S26 is executed

When the Step S26 is executed, the control unit 28 reports to the user. For example, the control unit 28 refers to the liquid intake table of FIG. 4B, and shows and reports the fact that the liquid intake amount of the user is smaller than the intake amount determined in advance. For example, the control unit 28 refers to the user information table of FIG. 4A, and shows and reports a message promoting a movement to a cooler place or activating an air conditioner when the user stays at a place where the temperature or the humidity is high for long periods. For example, the control unit 28 shows and reports a message recommending liquid intake on the display 27, when the sweating amount of the user is larger than a predetermined amount as a confirmation result of the Step S18. When the wristwatch 20 has a speaker, an alarm sound or a sound message may be output from the speaker.

The control unit 28 may perform each reporting to the user after the liquid intake amount of the user is confirmed in the Step S18 and it is determined that there is not intake for the predetermined time based on the clock result of the clock unit 26.

After the process of the Step S26 is executed, all processes of FIG. 7 are terminated. Even if all processes of FIG. 7 are terminated, the processes of FIG. 7 are repeated when the user puts on the wristwatch 20 (for example, there is an output of the biometric sensor 24b or the intra-body communication is achieved). The control unit 28 may start the flowchart of FIG. 7 when liquid is poured in the cup portion 50B (that is, the output of the load sensor 14 is changed).

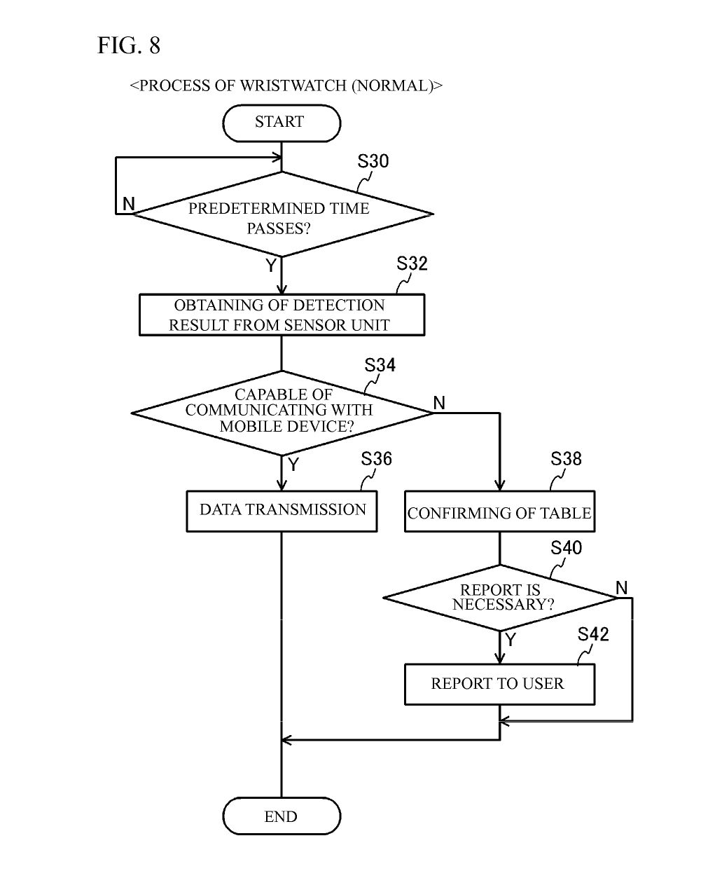

(Normal process of the wristwatch 20 (the control unit 28)) The wristwatch 20 can always obtain the information of the user or information of the surrounding environment via the sensor unit 24. Therefore, the control unit 28 executes processes using the information along the flowchart of FIG. 8. The flowchart of FIG. 8 is executed when the user puts on the wristwatch 20 as mentioned above.

In concrete, the control unit 28 waits until a predetermined time passes in Step S30 in the process of FIG. 8. In this case, at the time when the predetermined time passes, Step S32 is executed. The control unit 28 may determine the predetermined time to thirty minutes or one hour from the previous intra-body communication and may change the predetermined time based on the season or the surrounding environment of the user.

When step S32 is executed, the control unit 28 obtains the detection result of the sensor unit 24 and stores the detection result in the user information table (FIG. 4A.). Next, in Step S34, the control unit 28 determines whether the communication with the mobile device 30 can be achieved. When it is determined as “Yes”, the control unit 28 executes Step S36, transmits information obtained in the Step S32 to the mobile device 30, and terminates all processes of FIG. 8. On the other hand, when it is determined as “No” in the Step S34, Step S38 is executed.

When Step S38 is executed, the control unit 28 confirms the condition of the user (sweating amount or the like) or the condition of the surrounding environment (temperature and humidity of the surrounding) based on the user information table (FIG. 4A). Next, in Step S40, the control unit 28 determines whether the reporting to the user is necessary. When it is determined as “Yes”, the display 27 or the like reports to the user and all processes of FIG. 8 are terminated in Step S42. On the other hand, when it is determined as “No” in the Step S40, all processes of FIG. 8 are terminated. Even if all processes of FIG. 8 are terminated, the processes are repeated when the user puts on the wristwatch 20.

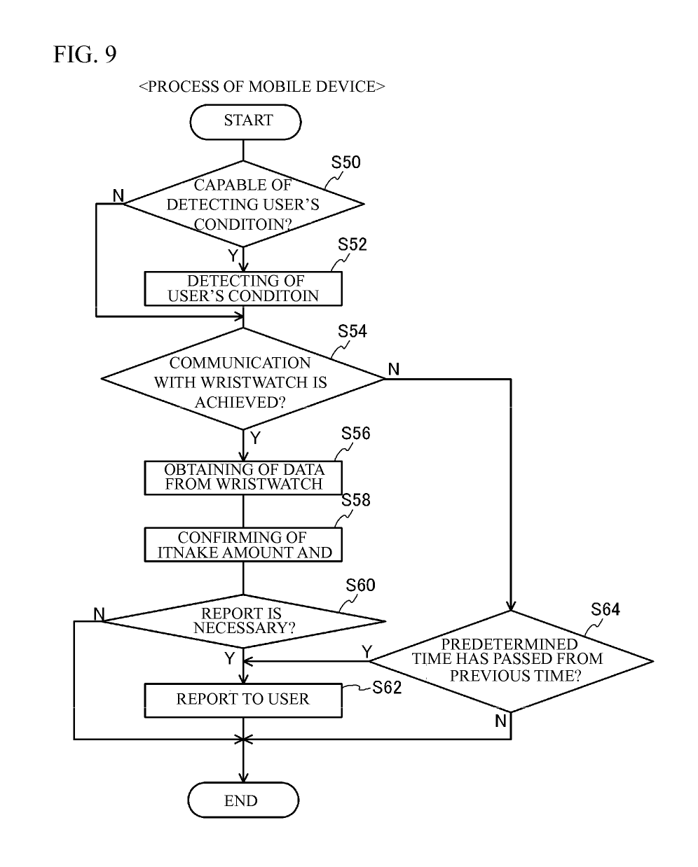

(Process by the mobile device 30 (control unit 43)) FIG. 9 illustrates a flowchart of processes executed by the control unit 43 of the mobile device 30.

In the processes of FIG. 9, the control unit 43 determines whether the condition of the user can be detected in Step S50. In this case, the control unit 43 determines whether the user uses the mobile device 30 (for example, the touch panel is used or not). When it is determined as “Yes” in the Step S50, Step S52 is executed. When it is determined as “No”, Step S54 is executed.

When the Step S52 is executed, the control unit 43 detects the condition of the user based on the outputs of the sensor unit 34, the imaging unit 40 and the image analysis unit 41. The obtaining of the position information of the user by a GPS module 34a and the obtaining of the biometric information of the user by a biometric sensor 34b may be omitted when similar information is input by the wristwatch 20.

The control unit 43 can obtain information of the temperature and the humidity of the user from the detection result of the thermo-hygrograph sensor 34c. The control unit 43 makes the imaging unit 40 (including an infrared light camera) take an image of a user holding the mobile device 30, makes the image analysis unit 41 analyze the image taken by the imaging unit 40, and detects the sweating condition or the biometric information based on the attribute of the user. After the Step S52, the Step S54 is executed.

When the Step S54 is executed, the control unit 43 determines whether the communication with the wristwatch 20 is achieved. When it is determined as “Yes”, that is, when the communication with the wristwatch 20 is achieved, Step S56 is executed.

When the Step 56 is executed, the control unit 43 obtains information relating to the liquid intake by the user and the user information from the wristwatch 20 and stores the information in the tables of FIG. 5A and FIG. 5B. The communication in this case may be an intra-body communication or a wireless communication.

Next, in Step S58, the control unit 43 confirms the liquid intake amount of the user and the condition of the user, based on the condition of the user detected in the Step S52 (only when the Step S52 is executed) and the user information obtained in the Step S56. In the Step S58, the condition relating to the heat of the user analyzed in the image analysis unit 41 and the output of the thermo-hygrograph sensor 34c can be used. Therefore, the control unit 43 can confirm the condition of the user with high accuracy.

The control unit 43 stores the confirmation result of the Step S58 (the liquid intake amount of the user and the condition of the user) in the flash memory 35 (FIG. 5A and FIG. 5B). Therefore, a daily log of the liquid intake is made in the tables of FIG. 5A and FIG. 5B. In this case, the control unit 43 may show a comparison with the last year on the display 36.

Next, in Step S60, the control unit 43 determines whether reporting to the user is necessary based on the confirmation result of the Step S58. When the reporting is not necessary, the control unit 43 terminates all processes of FIG. 9. When the reporting is necessary, Step S62 is executed.

When the Step S62 is executed, the control unit 43 performs the same reporting as the Step S26 of FIG. 7. The control unit 43 may show an indication of the liquid intake amount and the types (for example, sport drinks are recommended, and notice that coffee, tea, green tea, alcohol drink or the like having diuretic effect is not preferable is shown). Information amount of the display 36 of the mobile device 30 is larger than that of the display 27 of the wristwatch 20. Therefore, the control unit 43 may show a time, an amount, a type or the like of the liquid intake of next time, and may show comparison between a set liquid intake amount and an actual intake amount. When the display 27 of the wristwatch 20 can show the information, the display 27 of the wristwatch 20 may show the information.

The control unit 43 may report (inform) that the user lacks of the liquid intake amount and are at risk of heat stroke to email addresses of relatives of the user (that are registered in advance) when it is determined that the user is a children or a senior based on the output of the attribute estimation unit 41a.

When the process of the Step S62 is terminated, all processes of FIG. 9 are terminated.

On the other hand, when it is determined as “No” in the Step S54, that is, when the communication with the wristwatch 20 is not achieved, Step S64 is executed. And, the control unit 43 determines whether a predetermined time passes after the previous communication with the wristwatch 20 is performed. The predetermined time of this case is changed in accordance with season information that is determinable from the calendar unit 42, the previous liquid intake amount of the user and the condition of the user obtained in the Step S52. For example, when the previous liquid intake amount of the user is small in summer and the user is under a hot environment, the predetermined time may be shortened (for example, 15 minutes to 30 minutes). In a reverse case, the predetermined time may be elongated (for example a few hours).

When it is determined as “No” in the Step S64, that is, when the predetermined time is not passed, the control unit 43 terminated all processes of FIG. 9. On the other hand, when it is determined as “Yes” in the Step S64, that is, when the predetermined time has passed, the Step S62 is executed. And the control unit 43 reports to the user and terminates all processes of FIG. 9.

As mentioned above, in the embodiment, the wristwatch 20 and the mobile device 30 have the intra-body communication unit 22 that performs an intra-body communication with the device 10 for container (the intra-body communication unit 12) provided on the cup portion 50B of the container 50 that is capable of housing liquid and the control units 28 and 43 that input (obtain) information relating to the liquid amount of the cup portion 50B via the intra-body communication unit 22. Therefore, the wristwatch 20 and the mobile device 30 can obtain the information relating to the liquid amount (for example, liquid intake amount of a user) when the user holds the cup portion 50B and the intra-body communication is achieved. Thus, the control unit 28 and the control unit 43 can report to a user in view of the liquid intake amount of the user.

In the embodiment, the flash memories 25 and 35 store the liquid intake table (FIG. 4B and FIG. 5B). Therefore, the control units 28 and 43 refer to the table and can obtain information relating to the liquid intake amount of the user. Therefore, reporting based on this can be performed.

In the embodiment, the reporting is performed based on the detection results of the imaging unit 40, the expression detection unit 41b, the sweating estimation unit 41c, the sensor unit 34 and so on. It is therefore possible to perform an appropriate reporting in accordance with the condition of the user.

The container 50 of the embodiment has the cup portion 50B housing liquid and the intra-body communication unit 12 that is provided on the cup portion 50B and is capable of communicating with another device (the wristwatch 20 or the mobile device 30) by the intra-body communication. Therefore, it is possible to transmit the information relating to the liquid taken by the cup portion 50B to other devices when the user is holding the cup portion 50B. Thus, the other devices can get the information relating to the liquid at an appropriate timing.

In the embodiment, a description is given of the case where when the intra-body communication is being achieved between the device 10 for container and the wristwatch 20, the intra-body communication is performed. However, the structure is not limited to the case. For example, the communication between the device 10 for container and the wristwatch 20 may be achieved when the intra-body communication is achieved. And after that, a wireless communication via the wireless communication units 13 and 23 may be performed. In this case, at the timing when the intra-body communication is not achieved, the wireless communication may be stopped. When a predetermined time passes after the intra-body communication is off, the wireless communication may be stopped. In the latter case, it is possible to obtain the information (information relating to the liquid amount) that is obtained after the intra-body communication is off.

In the embodiment, a description is given of the case where the device 10 for container has the wireless communication unit 13, and the wristwatch 20 has the wireless communication unit 23. However, the structure is not limited to the case. Each device may lack of the wireless communication unit.

In the embodiment, the wristwatch 20 may be omitted from the information processing system 1 and the processes of FIG. 7 and FIG. 8 may be performed between the device 10 for container and the mobile device 30. In this case, the processes of the Step S20, the Step S22 and so on may be omitted. In this case, the liquid intake amount is obtained by the mobile device 30 that a user puts on. Therefore, it is not necessary to provide the function to identify the user in the device 10 for container. When a plurality of users (for example, family) share the container 50, it is possible to easily identify the user taking liquid with use of the container 50.

In the embodiment, a description is given of the case where the device 10 for container is provided on the cup portion 50B. However, the structure is not limited to the case. For example, the device 10 for container may be provided on the first portion 50A of the container 50. In this case, a reduction amount of the liquid in the first portion 50A may be estimated as the liquid intake amount of a user.

The flowcharts of FIG. 7 to FIG. 9 described in the embodiment may be arbitrarily combined. The order of each step may be changed. A part of the roles of the wristwatch 20 and the mobile device 30 may be changed. Needless to say, modification or application of the embodiment may be allowed.

In the embodiment, a description is given of the case where the electrode unit 11 of the device 10 for container is provided at a position of the cup portion 50B that could be easily touched by a hand of a user. However, the structure is not limited to the case. For example, the electrode unit may be provided on an opening portion (a portion that a mouth of a user contacts) of the cup portion 50B instead of or with the position that could be easily touched by the hand of the user.

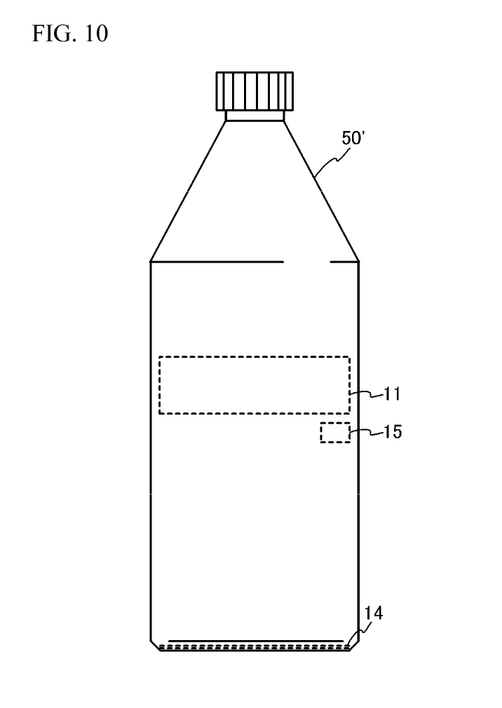

In the embodiment, a description is given of the case where the container 50 is a water bottle. However, the structure is not limited to the case. A cup or a PET bottle (plastic bottle) may be used as the container. For example, in a case of the PET bottle, as illustrated in FIG. 10, the electrode unit 11 (sheet-shaped electrode) may be provided on a portion of a PET bottle 50′ that could be easily touched by a hand. And, the load sensor 14 (load cell or the like) may be provided on a bottom of the PET bottle 50′. And, the memory 15 or the control unit 16 may be provided on any portion of the PET bottle 50′. In a case of a container having a handle such as a mug cup, at least a part (for example, a component for communication such as an electrode) of the device 10 for container may be provided on the handle. The component for communication may be engaged with the handle, and may be detachable.

When a user puts on a device having an intra-body communication function or a near field communication function and a liquid container that user uses has a communication function, a total intake amount of the user can be recorded automatically even if a house cup is used, a cup at a workplace is used or a drink is bought.

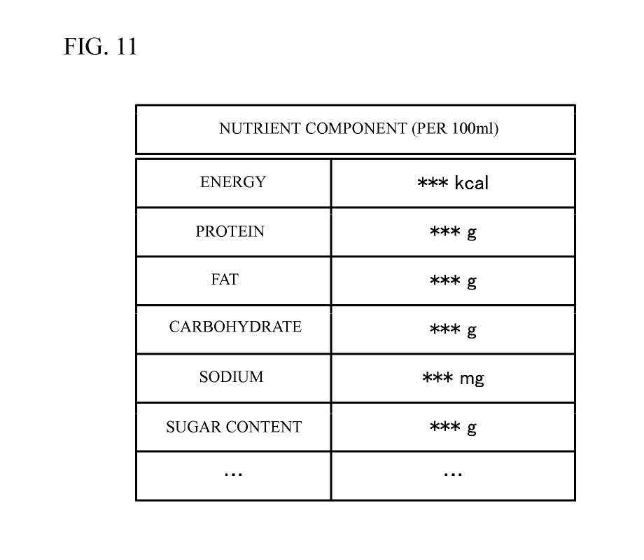

When the container is the PET bottle 50′ or a can, content of the PET bottle 50′ or the can is clear. Therefore, the memory 15 may store data of nutrient component illustrated in FIG. 11. In this case, when the device 10 for container transmits the liquid intake amount of a user to the wristwatch 20 or the mobile device 30, the data of nutrient component may be transmitted together. In this case, the control units 28 and 48 can report to the user in view of the data of the nutrient component. That is, when the user takes too much salt content, sugar content or calorie, the control units 28 and 48 can report the fact. An amount of salt content, sugar content or the like which a user can take differs in accordance with chronic disease of the user. Therefore, when the user registers the chronic disease or the like, it is possible to get an appropriate report. In a case of an alcohol can, it is possible to record an alcohol intake amount and report to the user.

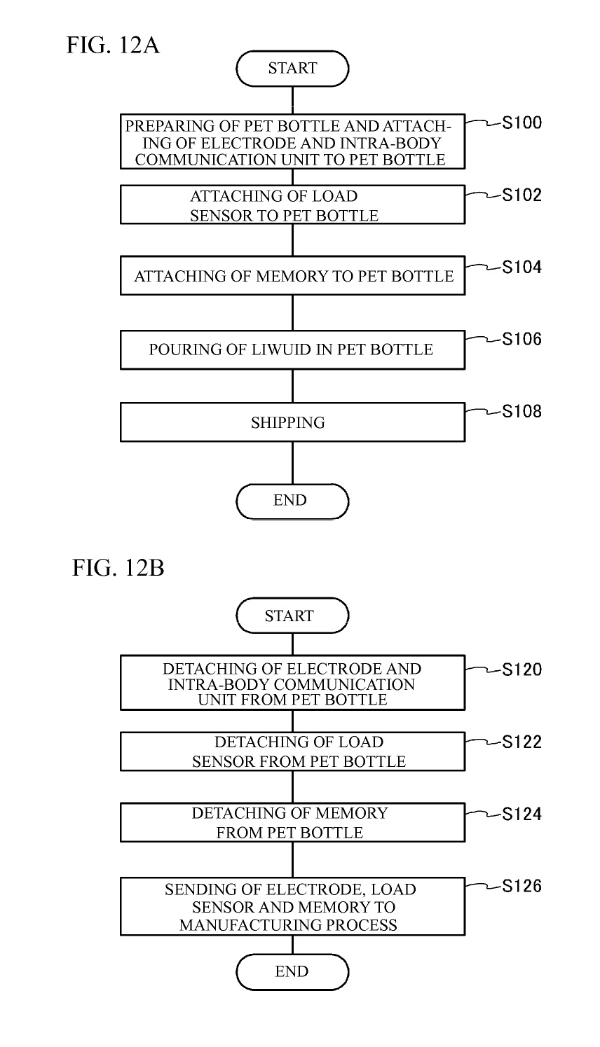

Here, a description will be given of a manufacturing method of a PET bottle drink using the PET bottle 50′ with reference to a flowchart of FIG. 12A. When a PET bottle drink is manufactured, the PET bottle 50′ is prepared in Step S100 of FIG. 12A. And, the electrode unit 11 and the intra-body communication unit 12 are attached to the PET bottle 50′.

Next, in Step S102, the load sensor 14 is attached to the PET bottle 50′. Next, in Step S104, the memory 15 is attached to the PET bottle 50′. The order of the attachment of the electrode unit 11, the intra-body communication unit 12, the load sensor 14 and the memory 15 is not limited to the order of FIG. 12A.

Next, in Step S106, liquid (drink) is poured in the PET bottle 50′. After that, a process such as attaching a cap to the PET bottle 50′ is performed. After that, in Step S108, the PET bottle drink is shipped.

When the device 10 for container can be mounted on a single label, the label may be adhered to the PET bottle. In this case, the Step S100 to the Step S104 may be performed together in a single process.

Next, a description will be given of a recycle process of the PET bottle 50′ with reference to FIG. 12B. The recycle process is a process performed after collecting used PET bottles 50′.

In FIG. 12B, in Step S120, the electrode unit 11 is detached from the collected PET bottles 50′. Next, in Step S122, the load sensor 14 is detached from the collected PET bottles 50′. Next, in Step S124, the memory 15 is detached from the collected PET bottles 50′. The order of detaching of the electrode unit 11, the intra-body communication unit 12, the load sensor 14 and the memory 15 is not limited to the order of FIG. 12B. When the device 10 for container can be mounted on a single label, the label may be detached from the PET bottle. In this case, the Step S120 to the Step S124 may be performed in a single process. The PET bottle itself may be re-produced as polyester fiber (egg packs, work clothes, carpet or the like). In this case, the device 10 for container may be attached to a new PET bottle. The content of the memory 15 may be re-written when the memory 15 is attached to a PET bottle of which category is different. When the device 10 for container is collected through a fractional recovery, the flowchart of FIG. 12B can be simplified.

And, in Step S126, the detached electrode unit 11, the detached load sensor 14 and the detached memory 15 are brought to the manufacturing process of the PET bottle drink (FIG. 12A).

In the manufacturing process of the PET bottle drink, it is checked whether the electrode unit 11, the load sensor 14 and the memory 15 brought in the Step S126 can be re-used. When they can be re-used, they will be used in the Step S100 to the Step S104.

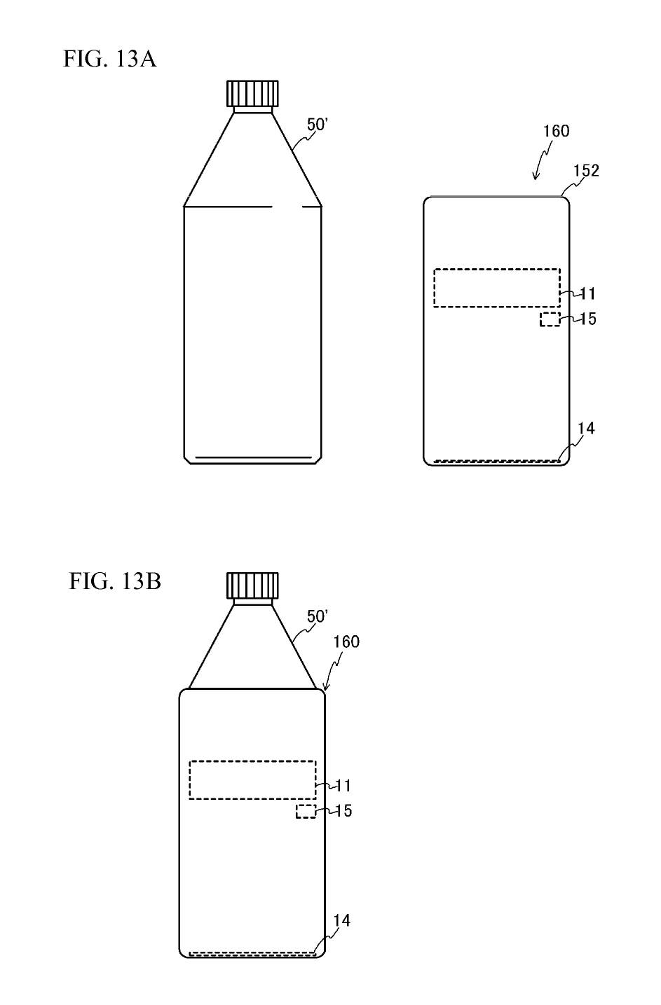

In the above-mentioned embodiment, a description is given of the case where the device 10 for container is directly attached to the PET bottle 50′. However, the structure it not limited to the case. For example, as illustrated in FIG. 13A, a cover 160 for a PET bottle on which the device 10 for container is mounted may be prepared, separately from the PET bottle 50′. The PET bottle cover 160 in this case has a cover main body 152, for example, made of materials having warm property and the device 10 for container having the electrode unit 11, the load sensor 14, the memory 15 and so on. Even if the PET bottle 50′ is separated from the cover 160 for PET bottle, the same function as the PET bottle illustrated in FIG. 10 can be achieved when the cover 160 for PET bottle is fixed to the PET bottle 50′ as illustrated in FIG. 13B. When the cover 160 for PET bottle is used, it is not necessary to provide the device 10 for container on each of the PET bottles 50′. It is therefore possible to reduce man-hour, cost or the like.

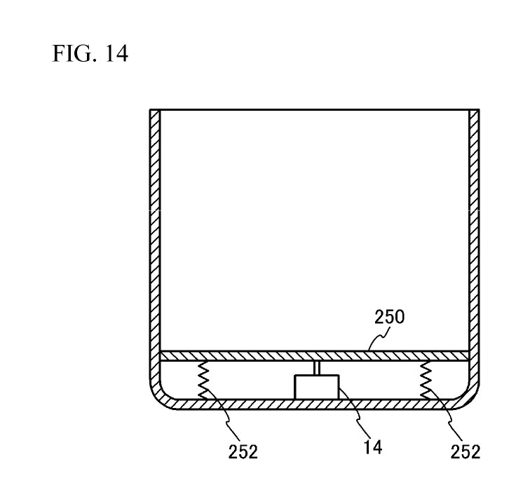

In the embodiment, a description is given of the case where the load cell is provided as the load sensor 14. However, the structure is not limited to the case. For example, as illustrated in FIG. 14, an inner bottom 250 that is capable of moving in the container (an up-and-down movement) may be provided in a container such as a cup or a PET bottle via an elastic member 252 such as a spring. And, a pressure sensor or the like as the load sensor 14 may be provided between the inner bottom 250 and the container. In this manner, even if a user holds the container, the liquid amount in the container can be detected by the load sensor 14.

In the embodiment, a description is given of the case where the device 10 for container is provided on a container for drink. However, the structure is not limited to the case. For example, the device 10 for container may be provided in a container of such as a hand soap or an alcohol sanitizer. In this manner, a user can collect information using the hand soap or the alcohol sanitizer with use of the mobile device 30. When the information is used, the informing relating to the usage of the hand soap or the alcohol sanitizer can be performed. An effect of the usage can be reviewed.

In the embodiment, a description is given of the case where the substance housed in the container is liquid (drink). However, the structure is not limited to the case. For example, the substance housed in the container may be a solid substance such as a medicine, food or Gel, gas such as oxygen, or a gaseous suction medicine.

In the embodiment, a description is given of the case where the intra-body communication units 12, 22 and 32 are provided on each device. However, the structure is not limited to the case. A near field communication unit that is capable of performing a near field communication may be provided on each device. A Felica (registered trademark) module that is a RFID (Radio Frequency Identification) or a TransferJet (registered trademark) may be used as the near field communication.

In the embodiment, a description is given of the case where the mobile device 30 is a smart phone having a single hand size. However, a tablet type computer may be used as the mobile device 30. The mobile device 30 may have a sound recognition function and a user may speak to the microphone 38 “How much is water intake amount of today?”, the speaker 39 may outputs “smaller amount about 1 liter” and report the water intake amount of the user.

Instead of the wristwatch 20, glasses or a hearing aid device may have the intra-body communication function or a near field communication function.

The above-mentioned embodiments are preferable embodiments of the present invention. However, the embodiments are not limited to the cases. Other embodiments, variations and modifications may be made without departing from the scope of the present invention. The entire disclosure of the publication cited in the above description is incorporated herein by reference.

1. An electronic device comprising:
a communication unit that performs a near field communication or an intra-body communication with a container-side communication unit that is provided on a container that is capable of housing substance or a cover that covers at least a part of the container; and
an input unit that inputs information relating to the substance in the container via the container-side communication unit and the communication unit.

2. The electronic device of claim 1, further comprising a storage unit that stores an intake amount of the substance by a user based on the information that is input by the input unit.

3. The electronic device of claim 2, wherein the storage unit stores a total intake amount of the user for a predetermined period.

4. The electronic device of claim 2, further comprising a first report unit that reports an amount of which the user should take of the substance next and a time when the user should take the substance, based on the information input by the input unit.

5. The electronic device of claim 1, further comprising a second report unit that reports when the communication unit does not perform the communication for a predetermined period.

6. The electronic device of claim 5, wherein the second report unit reports to a person that is different from the user.

7. The electronic device of claim 5, further comprising a setting unit that sets the predetermined period in accordance with an environment of the user.

8. The electronic device of claim 1, further comprising a detector that detects a datum relating to a body sensory of the user.

9. The electronic device of claim 8, wherein the detector has a biometric sensor that detects biometric information of the user.

10. The electronic device of claim 8, wherein the detector has an environment sensor that detects information relating to an environment where the user is positioned.

11. The electronic device of claim 8, wherein the detector has an imaging unit that takes an image of the user.

12. The electronic device of claim 1, wherein:
the container-side communication unit is provided on the container; and
the input unit inputs a component of the substance.

13. The electronic device of claim 12, further comprising a calculator that calculates an intake amount of the component based on the information relating to the amount of the substance that is input by the input unit and the information of the component of the substance.

14. The electronic device of claim 1, wherein the substance is a liquid.

15. A container comprising:
a container main body that houses substance; and
a communication unit that is provided on the container main body and is capable of communicating with another device via a human body or a near field communication.

16. The container of claim 15, wherein:
the communication unit has an electrode unit that is used for communication via the human body; and
the electrode unit is located on a position of the container main body that is held by the user.

17. The container of claim 15, wherein:
the communication unit has an electrode unit that is used for communication via a human body; and
the electrode unit is provided near an opening of the container main body through which the user takes the substance.

18. The container of claim 16, wherein the electrode unit has a sheet-shaped electrode.

19. The container of claim 15, further comprising a detector that detects first information relating to the amount of the substance.

20. The container of claim 19, wherein the detector detects a changing of the amount of the substance.

21. The container of claim 19, wherein the detector is a load sensor that is provided on a bottom of the container main body.

22. The container of claim 19, further comprising a first storage unit that stores a detection result of the detector,
wherein the communication unit transmits the first information stored in the first storage unit to the another device.

23. The container of claim 15, further comprising a second storage unit that stores second information relating to the substance,
wherein the communication unit transmits the second information stored in the second storage unit to the another device.

24. The container of claim 15, wherein the communication unit is detachable.

25. The container of claim 15, wherein the substance is a liquid.

26. A manufacturing method of a container comprising:
housing substance in a container main body; and
attaching a communication unit to the container, the communication unit being capable of communicating with another device via a human body or a near field communication.

27. The manufacturing method of the container of claim 26, further comprising providing a load sensor on a bottom of the container main body.

28. The manufacturing method of the container of claim 27, further comprising providing a storage unit storing information relating to the substance on the container main body.

29. A manufacturing method of a container comprising:
detaching a communication unit from a first container, the communication unit being capable of communicating with another device via a human body or a near field communication; and
attaching the detached communication unit to a second container that is different from the first container.

30. The manufacturing method of the container of claim 29, further comprising:
detaching a load sensor from the first container; and
attaching the detached load sensor to the second container or a third container that is different from the second container.

31. A mounting fixture for a container comprising:
a mounting fixture portion that can be fixed to a container where substance is housed; and
a communication unit that is provided on the mounting fixture portion and is capable of communicating with another device via a human body or a near field communication.
